(19) United States
(12) Patent Application Publication
(10) Pub. No.: US 2013/0250128 A1
(43) Pub. Date: Sep. 26, 2013

(54) DETECTOR FOR DETECTING MULTIPLE HDMI SIGNALS

(71) Applicant: Cheng-Si Wang, Changhua Hsien (TW)

(72) Inventor: Cheng-Si Wang, Changhua Hsien (TW)

(21) Appl. No.: 13/425,996

(22) Filed: Mar. 21, 2012

(51) Int. Cl. H04N 17/00

(52) U.S. Cl. 348/180; 348/E17.001

(57) ABSTRACT

A detector for detecting multiple HDMI signals includes an HDMI source port, an HDMI objective port and a status detecting unit. The HDMI source port includes a CEC pin, an HTPLG pin and a DDC pin. The HDMI objective port includes a CEC pin, an HTPLG pin and a DDC pin set. The status detecting unit includes an input port, an output port and a status crosscheck module. The input port includes a CEC pin, an HTPLG pin and a DDC pin set respectively connected to those of the HDMI source port. The output port includes a CEC pin, an HTPLG pin and a DDC pin set respectively connected to those of the HDMI objective port. The status crosscheck module detects whether the HTPLG pin and the CEC pin of the input port receive signals or not.

### BACKGROUND OF THE INVENTION

1. Field of the Invention

The present invention relates to an electrical signal detector, and more particularly to a detector for detecting multiple HDMI signals.

2. Description of Related Art

High definition multimedia interface (HDMI) is one of various interfaces for transmitting full digital images and sounds and is suitable for digital TV set-top-boxes, DVD players, computers, TVs, audios and TV game players. A standard HDMI adapter has nineteen pins. Besides the pins for transmitting data and clock, three of the nineteen pins are provided for confirming whether the HDMI adapter is correctly interconnect between two devices. The three pins are a consumer electronics control (CEC) pin, a hot plug detect (HTPLG) pin and a display data channel (DDC) pin set.

The CEC pin is provided for transmitting an audiovisual (AV) link protocol signal of industrial standard such that a single remoter is able to control multiple AV equipments. For instance, a source device, such as a DVD player or a satellite receiver, can interact with a TV (sink device). While an HDMI cable is connected between the DVD player and the TV and the DVD player is activated, the CEC pin transmits a signal to the TV to turn on the TV. Likewise, while the TV is switched off, the CEC pin transmits the signal to the DVD player to switch on the DVD player.

The HTPLG pin is provided for detecting whether the HDMI cable of an AV equipment is connected to another AV equipment. When the DVD player is connected to the TV via the HDMI cable, the TV gets +5 voltages from the HTPLG pin to recognize the DVD player. While the DVD player is switched off or not actuated, the +5 voltages should be undetectable on the HTPLG pin. However, some products are designed to always provide the +5 voltages. The TV will incorrectly recognize the existence of the DVD player based on the +5 voltages from the HTPLG pins.

The DDC pin set includes a serial clock input (SCL) pin and a serial data (SDA) pin. While the SDA pin transmits the signal, the SCL pin provides an I²S signal of 100 kHz clock rate to the DVD player for determining the video format supported by the TV via the DDC pin, such that the DVD player can provide a suitable signal, like standard-definition signal, high-definition signal or full high-definition signal.

The conventional HDMI detector takes one of the pins to detect the connection and easily generates wrong feedback information, for example, the TV may incorrectly recognize the DVD player while the DVD player actually does not transmit any signals. For another example, when the TV does not have a CEC pin function and the DVD player transmits signals to the TV via the DDC pin, a function of the CEC pin of the DVD player may incorrectly recognize the TV as nonoperated. In another example, when the TV has the function of the CEC pin and constantly provides +5 voltages to the HTPLG pin, the DVD player may recognize the +5 voltages of the HTPLG pin of the TV and incorrectly activate the TV.

To overcome the shortcomings, the present invention tends to provide a detector for detecting multiple HDMI signals to mitigate or obviate the aforementioned problems.

### SUMMARY OF THE INVENTION

The main objective of the invention is to provide a detector for detecting multiple HDMI signals; the detector includes at least one HDMI source port, an HDMI objective port and a status detecting unit.

Each of the at least one HDMI source port includes a consumer electronics control (CEC) pin, a hot plug detect (HTPLG) pin and a display data channel (DDC) pin set. Each DDC pin set includes a serial clock input (SCL) pin and a serial data (SDA) pin.

The HDMI objective port includes a CEC pin, an HTPLG pin and a DDC pin set. The DDC set includes an SCL pin and an SDA pin.

The status detecting unit is electrically connected to the at least one HMI source port and the HDMI objective port, and includes at least one input port, an output port and a status crosscheck module.

Each of the at least one input port includes a CEC pin, an HTPLG pin and a DDC pin set. The CEC pin is electrically connected to the CEC pin of a corresponding one of the at least one HDMI source port. The HTPLG pin is electrically connected to the HTPLG pin of a corresponding one of the at least one HDMI source port. The DDC pin set includes an SCL pin and an SDA pin respectively connected to the SCL pin and the SDA pin of a corresponding one of the at least one HDMI source port.

The output port includes a CEC pin, an HTPLG pin and a DDC pin set. The CEC pin is electrically connected to the CEC pin of the HDMI objective port. The HTPLG pin is electrically connected to the HTPLG pin of the HDMI objective port. The DDC pin set includes an SCL pin and an SDA pin respectively and electrically connected to the SCL pin and the SDA pin of the HDMI objective port.

The status crosscheck module detects whether the HTPLG pin and the CEC pin of one of the at least one input port receive voltage signals or not, and detects whether the HTPG pin and the CEC pin of the output port receive voltage signals or not.

When both of the HTPLG pin and the CEC pin of one of the at least one input port receive the voltage signal, the corresponding one of the at least one HDMI source port, which is connected to the one of the at least one input port, is confirmed to be correctly connected.

When both of the HTPLG pin and the CEC pin of the output port receive the voltage signal, the HDMI objective port connected to the output port of the status detecting unit is confirmed to be correctly connected.

Other objects, advantages and novel features of the invention will become more apparent from the following detailed description when taken in conjunction with the accompanying drawings.

### BRIEF DESCRIPTION OF THE DRAWINGS

FIG. 1 is a block diagram of a first embodiment of a detector for detecting multiple high definition multimedia interface (HDMI) signals in accordance with the present invention;

FIG. 2 is a block diagram of a second embodiment of the detector for detecting multiple HDMI signals in accordance with the present invention;

FIGS. 3A and 3B are circuit diagrams of a first HDMI source port of the detector for detecting multiple HDMI signals in accordance with the present invention;

FIGS. 3C and 3D are circuit diagrams of a second HDMI source port of the detector for detecting multiple HDMI signals in accordance with the present invention;

FIGS. 4A, 4B, 4C, 4D and 4E are circuit diagrams of a status detecting unit of the detector for detecting multiple HDMI signals in accordance with the present invention; and

FIGS. 5A and 5B are circuit diagrams of an HDMI objective port of the detector for detecting multiple HDMI signals in accordance with the present invention.

### DETAILED DESCRIPTION OF PREFERRED EMBODIMENT

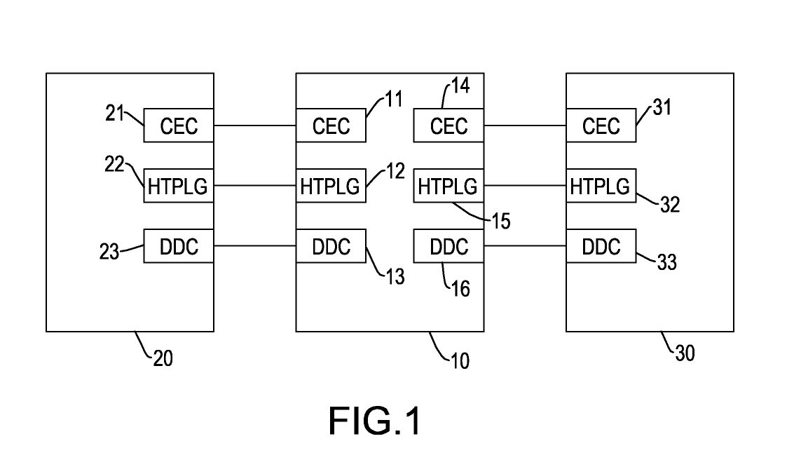

With reference to FIG. 1, a detector for detecting multiple high definition multimedia interface (HDMI) signals in accordance with a first embodiment of the present invention comprises a status detecting unit 10, a first HDMI source port 20 and an HDMI objective port 30. The first HDMI source port 20 and the HDMI objective port 30 are electrically connected to the status detecting unit 10.

The status detecting unit 10 includes multiple pins and a status crosscheck module. The pins mainly include an input port and an output port. The input port includes a consumer electronics control (CEC) pin 11, a hot plug detect (HTPLG) pin 12 and a display data channel (DDC) pin set 13. The output port includes a CEC pin 14, an HTPLG pin 15 and a DDC pin set 16. The status crosscheck module is provided for determining whether the pins of the status detecting unit 10 receive signals or not.

The first HDMI source port 20 has multiple pins including a CEC pin 21, an HTPLG pin 22 and a DDC pin set 23. The CEC pin 21, the HTPLG pin 22 and the DDC pin set 23 of the first HDMI source port 20 are respectively and electrically connected to the CEC pin 11, HTPLG pin 12 and DDC pin set 13 of the corresponding input port of the status detecting unit 10.

The HDMI objective port 30 has multiple pins including a CEC pin 31, an HTPLG pin 32 and a DDC pin set 33. The CEC pin 31, the HTPLG pin 32 and the DDC pin set 33 of the HDMI objective port 30 are respectively electrically connected to the CEC pin 14, the HTPLG pin 15 and the DDC pin set 16 of the output port of the status detecting unit 10.

When the first HDMI source port 20 receives an HDMI signal, the status crosscheck module determines the statuses of the CEC pin 21 and the HTPLG pin 22 of the first HDMI source port 20, and further determines a clock signal of the DDC pin set 23, such that the status crosscheck module can recognize the correct HDMI signals from the CEC pin 21, the HTPLG pin 22 and the DDC pin set 23. The HDMI objective port 30 can output correct signals to the first HDMI source port 20, or the HDMI objective port 30 can output the correct signals received from the first HDMI source port 20 to an objective displayer.

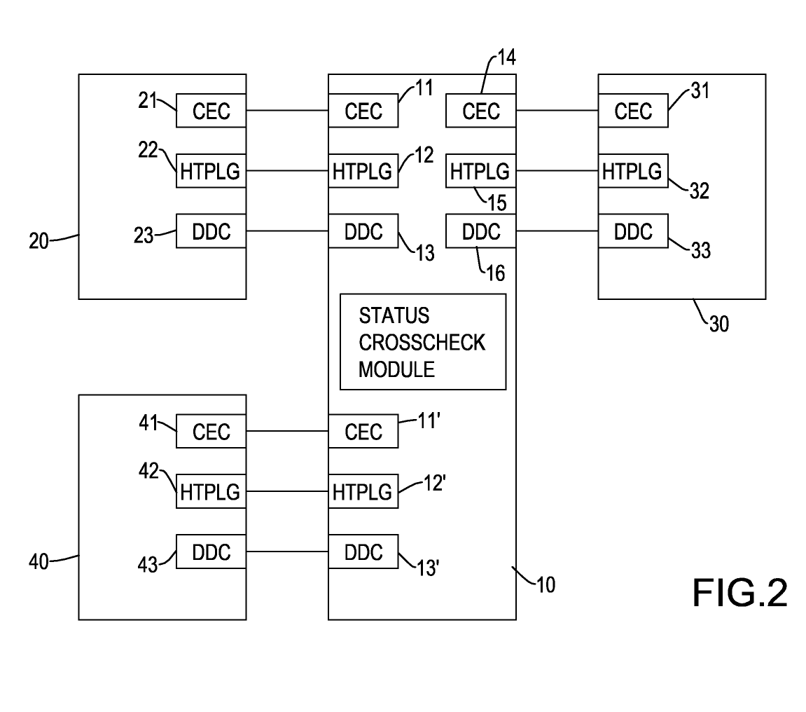

With reference to FIG. 2, in the second embodiment of the detector for detecting multiple HDMI signals in accordance with the present invention, the elements and effects of the second embodiment are same with the first embodiment except that the status detecting unit 10 further includes a second input port electrically connected to a second HDMI source port 40. The second HDMI source port 40 has a CEC pin 41, an HTPLG pin 42 and a DDC pin set 43. The second input port of the status detecting unit 10 has a CEC pin 11′, an HTPLG pin 12′ and a DDC pin set 13′ respectively and electrically connected to the CEC pin 41, the HTPLG pin 42 and the DDC pin set 43 of the second HDMI source port 40.

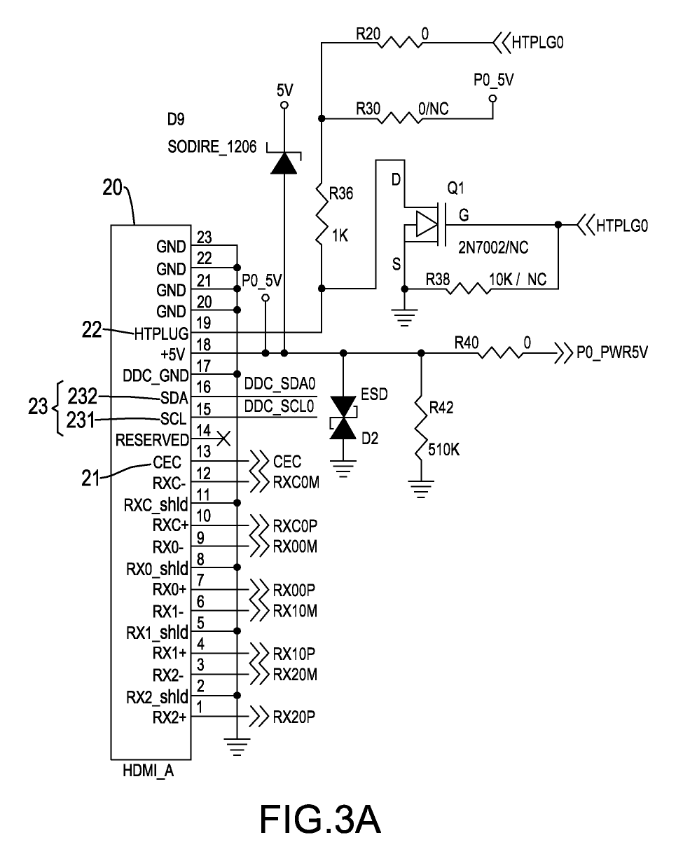

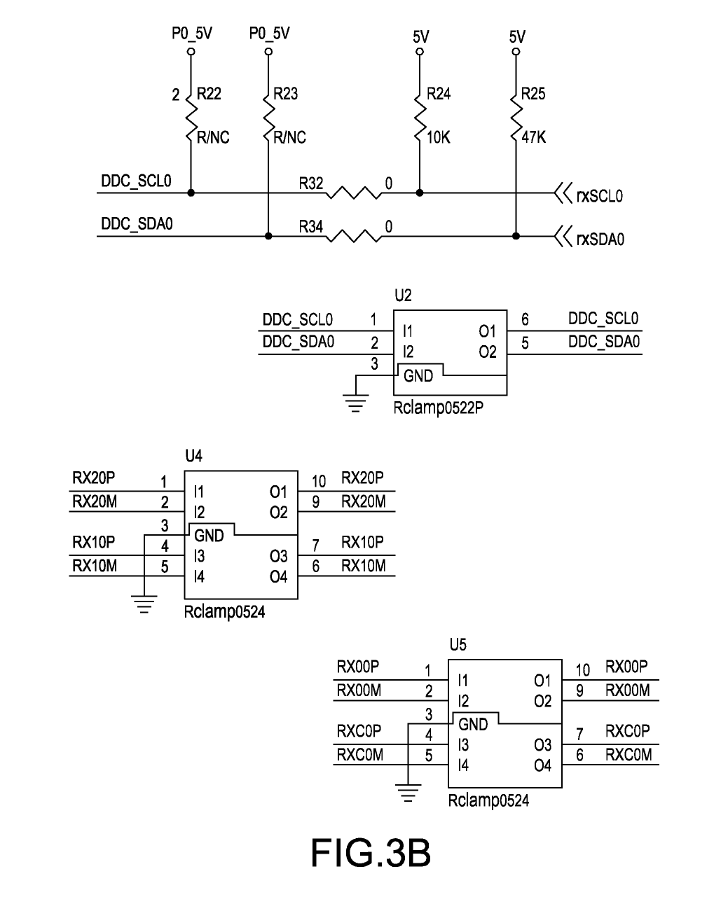

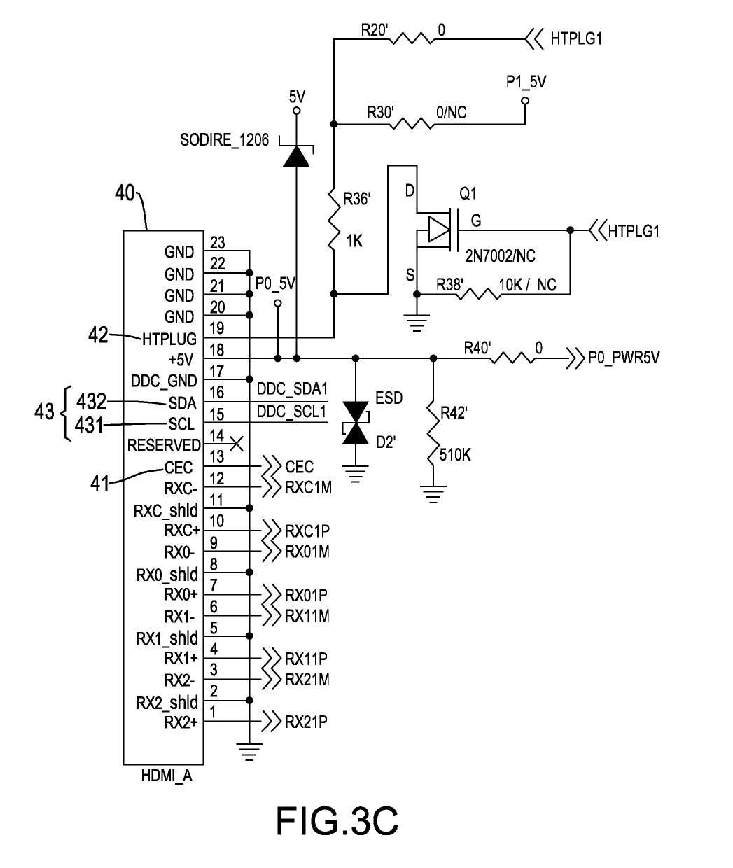

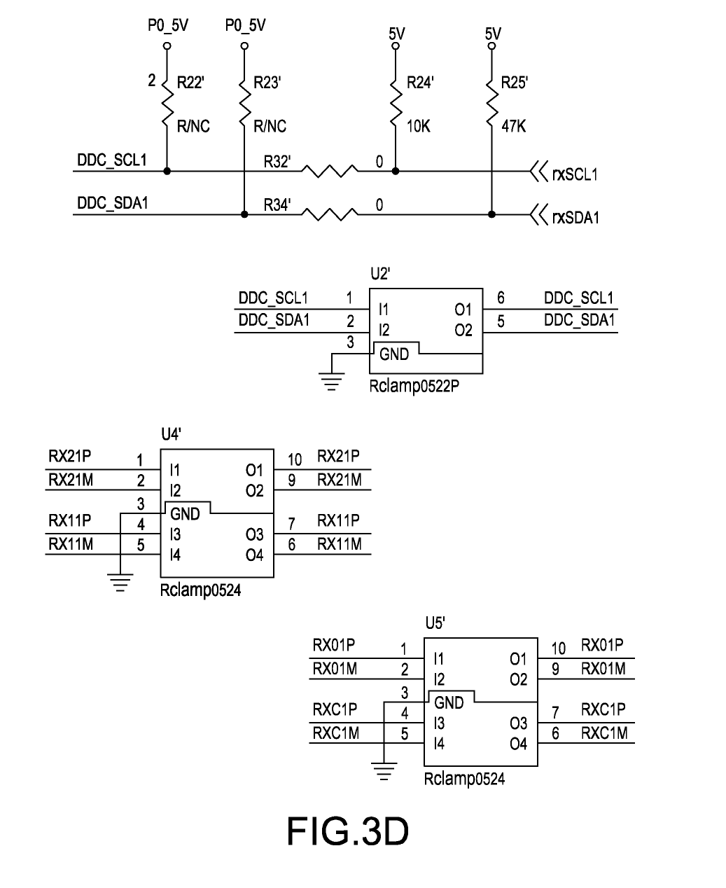

With reference to FIGS. 3C and 3D, in a circuit diagram of the first HDMI source port 20 and second HDMI source port 40, the HTPLG pin 22 of the first HDMI source port 20 is marked as HTPLUG. The DDC pin set 23 of the first HDMI source port 20 includes a serial clock input (SCL) pin 231 and a serial data (SDA) pin 232. The HTPLG pin 42 of the second HDMI source port 40 is marked as HTPLUG. The DDC pin set 43 of the second HDMI source port 40 includes an SCL pin 431 and an SDA pin 432.

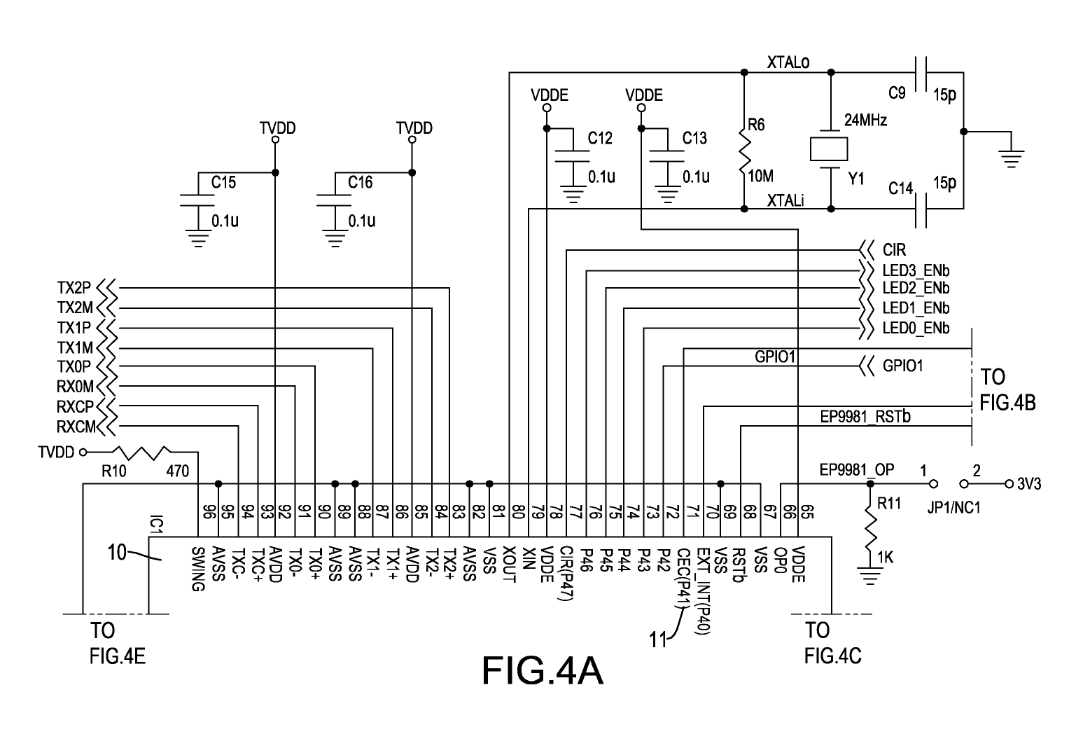

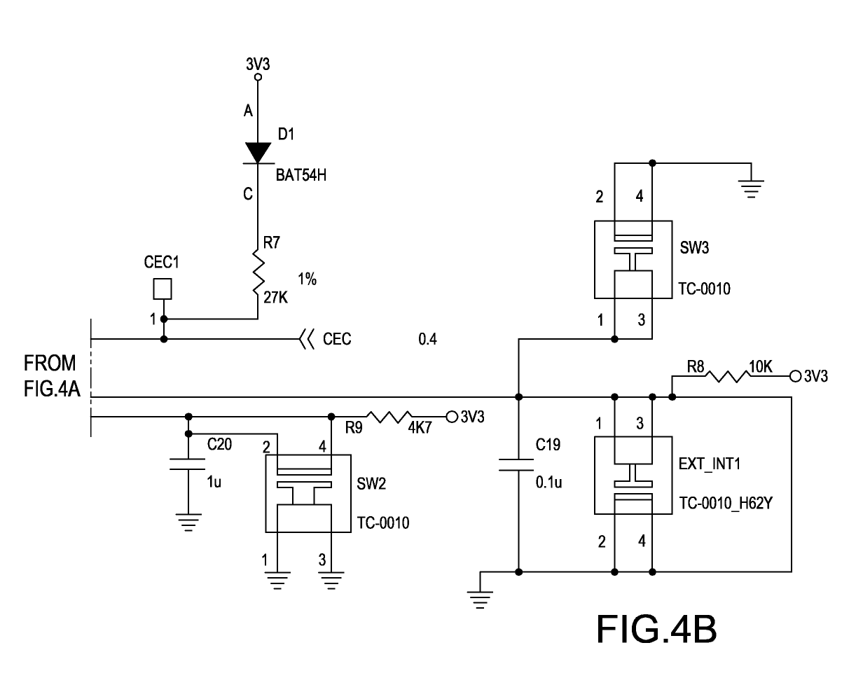

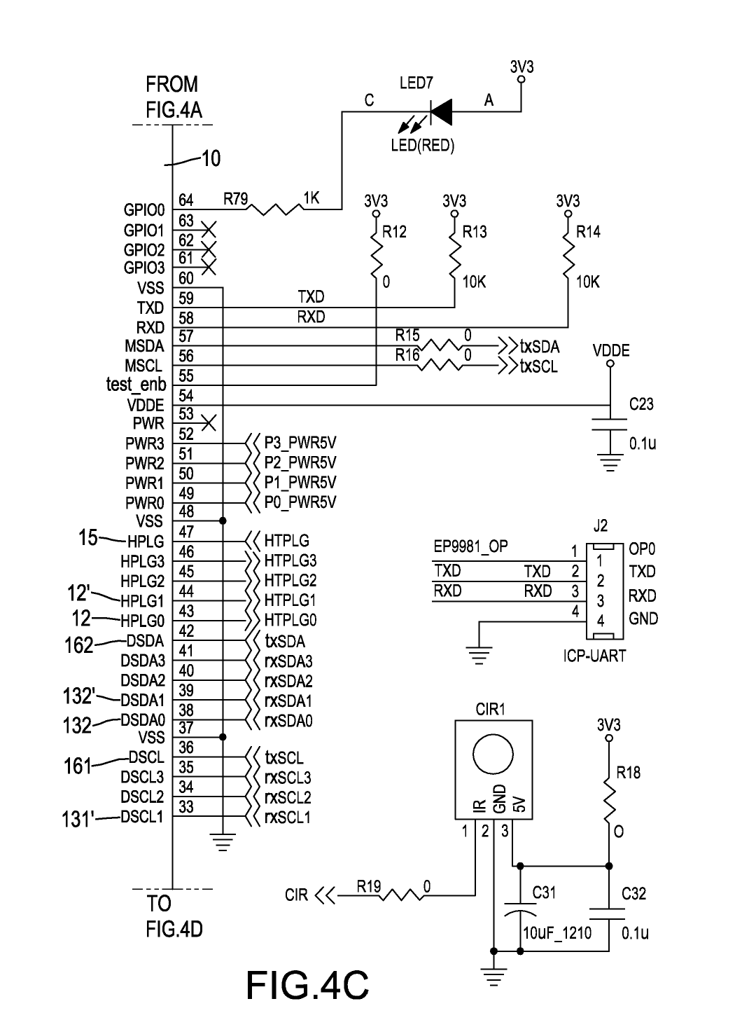

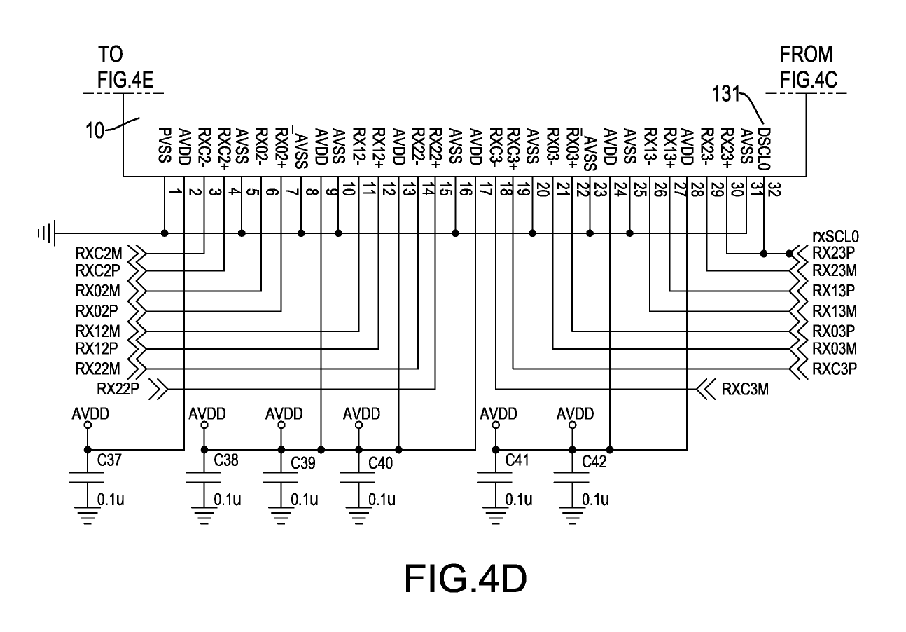

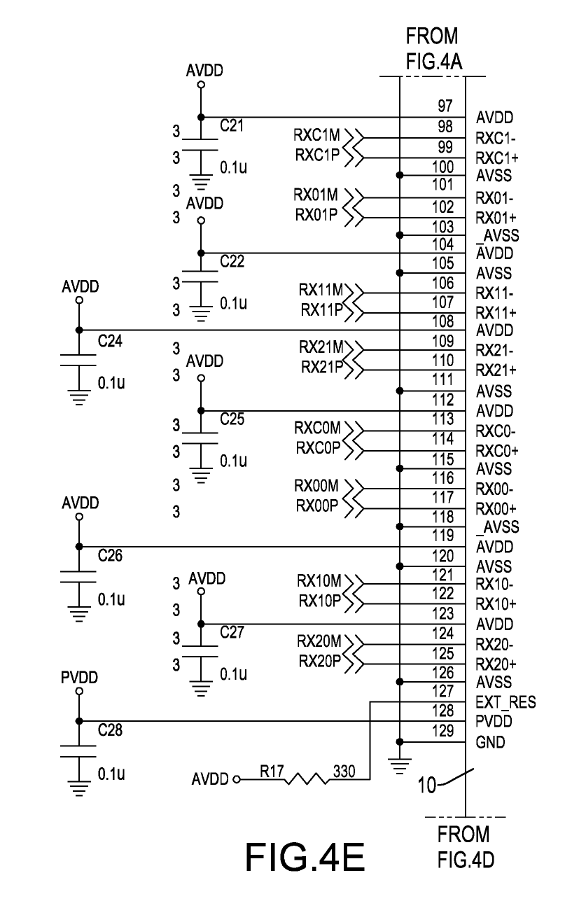

With reference to FIGS. 4A to 4E, the HTPLG pin 12 of the input port of the status detecting unit 10 is marked as HPLG0. The HTPLG pin 12′ of the second input port is marked as HPLG1. The DDC pin set 13 of the input port of the status detecting unit 10 includes an SCL pin 131 marked as DSCL0 and an SDA pin 132 marked as DSDA0. The DDC pin set 13′ of the second input port includes an SCL pin 131′ marked as DSCL1 and an SDA pin 132′ marked as DSDA1. The HTPLG pin 15 of the output port of the status detecting unit 10 is marked as HPLG. The DDC pin set 16 of the output port of the status detecting unit 10 includes an SCL pin 161 marked as DSCL and an SDA pin 162 marked as DSDA.

The pins of the first input port of the status detecting unit 10 are respectively and electrically connected to the pins of the first HDMI source port 20, such that the SCL pin 131 and the SDA pin 132 of the input port of the status detecting unit 10 are respectively electrically connected to the SCL pin 231 and the SDA pin 232 of the first HDMI source port 20. The pins of the second input port of the status detecting unit 10 are respectively electrically connected to the pins of the second HDMI source port 40, such that the SCL pin 131′ and the SDA pin 132′ of the second input port of the status detecting unit 10 are respectively and electrically connected to the SCL pin 431 and the SDA pin 432 of the second HDMI source port 40. Preferably, the status detecting unit 10 has four input ports. The HPLG pins of the four input ports are marked as HPLG0 to HPLG3, the SCL pins of the four input ports are marked as DSCL0 to DSCL3, and the SDA pins of the four input ports are marked as DSDA0 to DSDA3. Therefore, the four input ports are capable of connecting to four HDMI source ports.

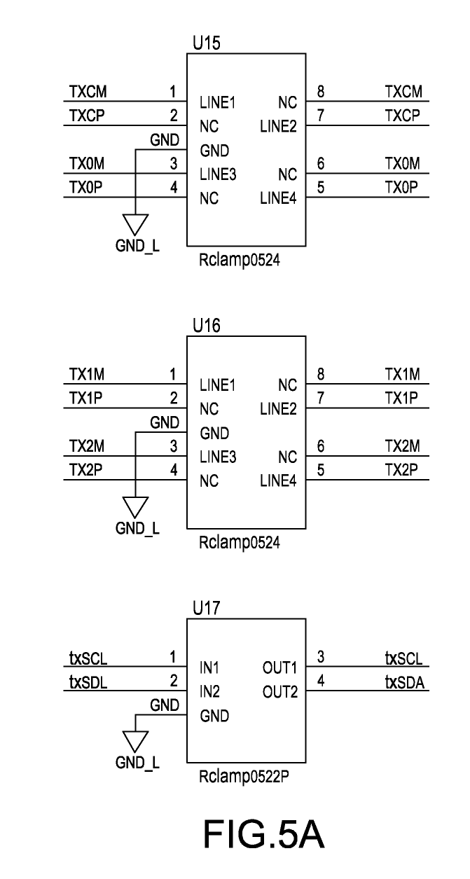

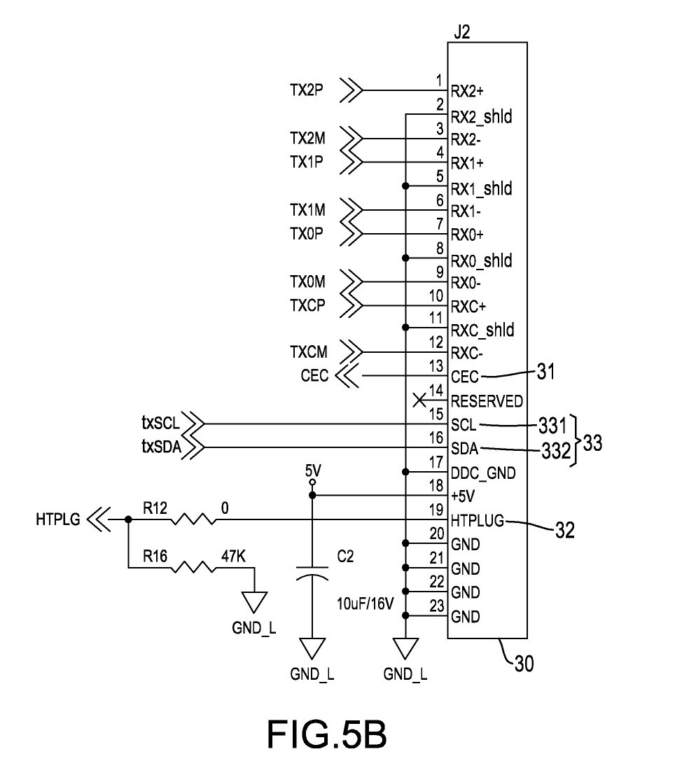

With reference to FIGS. 5A and 5B, the HTPLG pin 32 of the HDMI objective port 30 is marked as HTPLUG and is connected to the HTPLG pin 15 of the output port of the status detecting unit 10. The DDC pin set 33 of the HDMI objective port 30 includes an SCL pin 331 and an SDA pin 332 respectively connected to the SCL pin 161 and the SDA pin 162 of the DDC pin set 16 of the output port of the status detecting unit 10. When an HDMI signal is transmitted to the first HDMI source port 20 or the second HDMI source port 40, the status crosscheck module of the status detecting unit 10 determines whether the HTPLG pin 12 has +5 voltages or the HTPLG pin 12′ has +5 voltages, and determines whether the CEC pin 11 receives a voltage signal or the CEC pin 11′ receives the voltage signal for ensuring whether the HDMI signal has been correctly received by the first HDMI source port 20 or the second HDMI source port 40. For example, when the HTPLG pin 12 of the first HDMI source port 20 has +5 voltages and the CEC pin 11 receives the voltage signal, the status crosscheck module determines the first HDMI source port 20 as having a correct connection and receiving the HDMI signal. Or, the status crosscheck module further determines the signal received from the DDC pin set 13. If the SDA pin 132 of the DDC pin set 13 has signal transmissions and an I²S signal of 100 kHz clock rate is detected at the SCL pin 131 by the status crosscheck module, a connection between the first HDMI source port 20 and the input port of the status detecting unit 10 is confirmed. Therefore, the status detecting unit 10 can correctly select the first HDMI source port 20, which receives the HDMI signal, and output a corresponding signal to the HDMI objective port 30.

The status detecting unit 10 can detect the CEC pin 11 and the HTPLG pin 12 of the first HDMI source port 20 or the CEC pin 11′ and the HTPLG pin 12′ of the second HDMI source port 40, and further detect the DDC pin set 13 or the DDC pin set 13′, to avoid an incorrect connection.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A detector for detecting multiple high definition multimedia interface (HDMI) signals comprising:
at least one HDMI source port, and each of the at least one HDMI source port including a consumer electronics control (CEC) pin, a hot plug detect (HTPLG) pin and a display data channel (DDC) pin set, each DDC pin set including a serial clock input (SCL) pin and a serial data (SDA) pin;
an HDMI objective port including a CEC pin, an HTPLG pin and a DDC pin set, the DDC set including an SCL pin and an SDA pin; and
a status detecting unit electrically connected to the at least one HDMI source port and the HDMI objective port, and including:
at least one input port, and each of the at least one input port including:
a CEC pin electrically connected to the CEC pin of a corresponding one of the at least one HDMI source port;
an HTPLG pin electrically connected to the HTPLG pin of a corresponding one of the at least one HDMI source port; and
a DDC pin set including an SCL pin and an SDA pin respectively connected to the SCL pin and the SDA pin of a corresponding one of the at least one HDMI source port;
an output port including:
a CEC pin electrically connected to the CEC pin of the HDMI objective port;
an HTPLG pin electrically connected to the HTPLG pin of the HDMI objective port; and
a DDC pin set including an SCL pin and an SDA pin respectively and electrically connected to the SCL pin and the SDA pin of the HDMI objective port; and
a status crosscheck module detecting whether the HTPLG pin and the CEC pin of one of the at least one input port receive voltage signals or not, and detecting whether the HTPG pin and the CEC pin of the output port receive voltage signals or not;
wherein when both of the HTPLG pin and the CEC pin of one of the at least one input port receive the voltage signal, the corresponding one of the at least one HDMI source port, which is connected to the one of the at least one input port, is confirmed to be correctly connected;
wherein when both of the HTPLG pin and the CEC pin of the output port receive the voltage signal, the HDMI objective port connected to the output port of the status detecting unit is confirmed to be correctly connected.

2. The detector as claimed in claim 1, wherein the status crosscheck module detects whether the SCL pin of the DDC pin set of the corresponding one of the at least one input port receives a clock signal or not, and detects whether the SCL pin of the DDC pin set of the output port receives a clock signal or not;
wherein when the SCL pin of the corresponding one of the at least one input port receives the clock signal, the corresponding one of the at least one HDMI source port is capable of transmitting signals; wherein when the SCL pin of the output port receives the clock signal, the HDMI objective port is capable of transmitting signals.

3. The detector as claimed in claim 2, wherein when the status crosscheck module detects the SCL pin of the corresponding one of the at least one input port receiving the clock signal and the HTPLG pin and the CEC pin of the corresponding one of the at least one input port also receiving voltage signals, the corresponding one of the at least one HDMI source port has a correct correction and is capable of transmitting signals; when the status crosscheck module detects the SCL pin of the output port receiving the clock signal and the HTPLG pin and the CEC pin of the output port also receiving voltage signals, the HDMI objective port has a correct connection and is capable of transmitting signals.

4. The detector as claimed in claim 1, wherein a number of the at least one HDMI source port is multiple and a number of the at least one input port of the status detecting unit is also multiple to correspond to the multiple HDMI source ports, and the status detecting unit sequentially determines whether each of the multiple HDMI source ports receives signals or not for ensuring correct connection of all of the multiple HDMI source ports.

5. The detector as claimed in claim 2, wherein a number of the at least one HDMI source port is multiple and a number of the at least one input port of the status detecting unit is also multiple to correspond to the multiple HDMI source ports, and the status detecting unit sequentially determines whether each of the multiple HDMI source ports receives signals or not for ensuring correct connection of all of the multiple HDMI source ports.

6. The detector as claimed in claim 3, wherein a number of the at least one HDMI source port is multiple and a number of the at least one input port of the status detecting unit is also multiple to correspond to the multiple HDMI source ports, and the status detecting unit sequentially determines whether each of the multiple HDMI source ports receives signals or not for ensuring correct connection of all of the multiple HDMI source ports.
